(19) United States
(12) Patent Application Publication
(10) Pub. No.: US 2024/0425125 A1
(43) Pub. Date: Dec. 26, 2024

(54) SEALS AND SEAL ASSEMBLIES FOR WHEELS OF TRACK SYSTEMS

(71) Applicant: SOUCY INTERNATIONAL INC., Drummondville (CA)

(72) Inventors: Jeremie AUBIN-MARCHAND, St-Hugues (CA); Yan ROGER, Drummondville (CA)

(21) Appl. No.: 18/748,584

(22) Filed: Jun. 20, 2024

Related U.S. Application Data
(60) Provisional application No. 63/522,544, filed on Jun. 22, 2023.

(51) Int. Cl. B62D 55/088; F16J 15/32

(52) U.S. Cl. CPC B62D 55/088; F16J 15/32

(57) ABSTRACT

A seal, which is for a wheel of a track system, includes first and second portions. The first portion is resiliently deformable, and has inner and outer radial ends, the outer radial end being closer to a retaining portion of the wheel than the inner radial end. The second portion is connected to the first portion, is more rigid than the first portion and is configured to at least reinforce the first portion. A seal assembly having the seal and a cover is also disclosed.

### CROSS-REFERENCE TO RELATED APPLICATIONS

The present application claims priority to U.S. Provisional Patent Application No. 63/522,544, filed Jun. 22, 2023 entitled “Seals and Seal Assemblies for Wheels of Track Systems”, which is incorporated by reference herein in its entirety.

### TECHNICAL FIELD

The present application generally relates to seals and seal assemblies for wheels of track systems.

### BACKGROUND

Certain types of vehicles such as, recreational vehicles including, but not limited to, all-terrain vehicles, utility-terrain vehicles, and side-by-side vehicles, are equipped with track systems.

These track systems can present some inconveniences. Particularly, these track systems, when utilized in damp terrains or when subjected to cleaning processes such as pressure washing, various elements such as water, dirt and/or soap can penetrate the wheel assemblies of the track systems. This penetration can adversely affect the durability and functionality of these wheel assemblies. Specifically, these elements can permeate the wheel assemblies through the gaps between the assembly and the connecting shaft, thereby impairing the overall performance of both the wheel assembly and the entire track system.

Certain wheel assemblies in track systems incorporate seal assemblies. However, as these wheel assemblies may move laterally relative to an endless track of their track systems, the seal assemblies can be exposed to excessive wear, notably due to the interaction (e.g., contact) of debris between the seal assemblies and the lugs of the endless track, for instance. While some seals, such as mud seals, do exist, these are generally not suitable for use with high rotations per minute (RPMs).

In view of the above, there is evident demand for a technological solution that could effectively mitigate the aforementioned issues.

### SUMMARY

It is an object of the present technology to ameliorate at least some of the inconveniences present in the prior art.

According to one aspect of the present technology, there is provided a seal for a wheel of a track system. The seal includes a first portion and a second portion. The first portion is resiliently deformable and has an inner radial end and an outer radial end, the outer radial end being closer to a retaining portion of the wheel than the inner radial end. The second portion is connected to the first portion, is more rigid than the first portion and is configured to at least reinforce the first portion.

In some embodiments, the outer radial end is configured to at least partially abut the retaining portion of the wheel.

In some embodiments, the second portion is configured to at least partially abut the retaining portion of the wheel.

In some embodiments, the second portion includes a radial section, and a lateral section extending generally perpendicular to the radial section. The lateral section is configured to abut at least one of: the retaining portion and the outer radial surface.

In some embodiments, the first portion further includes a retention lip at the outer radial end, the retention lip being configured to engage with the retaining portion of the wheel for limiting axial movement of the seal with respect to the wheel.

In some embodiments, the first portion further includes a loading lip for providing a preload to the seal in response to being deformed.

In some embodiments, at least part of the loading lip extends over the second portion.

In some embodiments, at least one of the first portion is made of an elastomeric material, and the second portion is made of at least one of: a metallic material and a hard plastic.

In some embodiments, the first and second portions are connected to one another via overmolding.

In some embodiments, the first and second portions are selectively connected to one another.

In some embodiments, the first portion of the seal comprises at least two lips.

In some embodiments, each one of the at least two lips extends generally laterally outwardly and radially away from the inner radial surface.

In some embodiments, at least one of the first and second portions has at least one interlocker configured to interlock with part of the wheel.

In some embodiments, the at least one interlocker extends in at least one of an axial direction, and a radial direction.

In some embodiments, part of the first portion is static with respect to a part engaged thereto, and an other part of the first portion is dynamic with respect to a part engaged thereto.

According to another aspect of the present technology, there is provided a seal assembly for a wheel of a track system. The wheel has a lateral side, and the seal assembly includes a seal according to the above aspect or according to the above aspect and one or more of the above embodiments, as well as a cover configured to engage with the seal. The engagement of the cover with the seal causes at least partial resilient deformation of the first portion of the seal for sealing the lateral side of the wheel.

According to another aspect of the present technology, there is provided a seal assembly for a wheel of a track system. The seal assembly includes a seal and a cover. The seal has a first lateral surface and a second lateral surface. The cover has a first segment, a second segment and a sealing layer. The first segment is selectively engaged to the first lateral surface of the seal. The second segment extends generally perpendicular to the first section, and is configured to surround a shaft connectable to the wheel. The sealing layer at least partially surrounds the second section.

In some embodiments, the sealing layer is part of the cover.

In some embodiments, the sealing layer is part of the seal.

In some embodiments, a lateral surface of the cover is located laterally between inner and outer lateral sides of the wheel.

In some embodiments, the diameter of the cover is less than a quarter of the diameter of the wheel.

In some embodiments, the cover has a radius that is less than a difference between a radius of the wheel and a height of a lug of an endless track of the track system.

In some embodiments, in response to the wheel assembly abutting a lug of an endless track of a track system, the seal assembly is spaced from the lug.

According to another aspect of the present technology, there is provided a wheel assembly for a track system, the wheel assembly comprising a wheel connectable to a shaft and a seal assembly according to the above aspect or according to the above aspect and one or more of the above embodiments. The wheel defines a center hub for receiving at least one bearing and at least a part of the shaft, and has a lateral side. The seal assembly is configured to provide a seal between the shaft and the lateral side of the wheel.

According to another aspect of the present technology, there is provided a wheel assembly for a track system. The wheel assembly includes a shaft, first and second wheels, at least one seal assembly, and a cover. The first wheel is rotationally connected to the shaft on a first end of the shaft. The second wheel is rotationally connected to the shaft on a second end of the shaft. At least one of the first wheel and the second wheel has a retaining portion defining a recess. The at least one seal assembly is selectively connected to the at least one of the first wheel and the second wheel for selectively sealing a lateral side of the at least one of the first wheel and the second wheel. The at least one seal assembly includes a seal with first and second portions. The first portion is resiliently deformable and has an inner radial end and an outer radial end, the outer radial end being closer to a retaining portion of the wheel than the inner radial end. The second portion is connected to the first portion, the second portion being more rigid than the first portion and being configured to at least reinforce the first portion. The cover selectively engaged to the seal.

In some embodiments, the outer radial end is configured to at least partially abut the retaining portion of the wheel.

In some embodiments, the second portion is configured to at least partially abut the retaining portion of the wheel.

In some embodiments, the second portion includes a radial section, and a lateral section extending generally perpendicular to the radial section, the lateral section being configured to abut at least one of: the retaining portion and the outer radial surface.

In some embodiments, the first portion further includes a retention lip at the outer radial end, the retention lip being configured to engage with the retaining portion of the wheel for limiting axial movement of the seal with respect to the wheel.

In some embodiments, the first portion further includes a loading lip for providing a preload to the seal in response to being deformed.

In some embodiments, at least part of the loading lip extends over the second portion.

In some embodiments, at least one of the first portion is made of an elastomeric material, and the second portion is made of at least one of: a metallic material and a hard plastic.

In some embodiments, the first and second portions are connected to one another via overmolding.

In some embodiments, the first and second portions are selectively connected to one another.

In some embodiments, the first portion of the seal comprises at least two lips.

In some embodiments, each one of the at least two lips extends generally laterally outwardly and radially away from the inner radial surface.

In some embodiments, at least one of the first and second portions has at least one interlocker configured to interlock with part of the wheel.

In some embodiments, the at least one interlocker extends in at least one of an axial direction, and a radial direction.

In some embodiments, part of the first portion is static with respect to a part engaged thereto, and an other part of the first portion is dynamic with respect to a part engaged thereto.

In some embodiments, the sealing layer is part of the cover.

In some embodiments, the sealing layer is part of the seal.

In some embodiments, a lateral surface of the cover is located laterally between inner and outer lateral sides of the wheel.

In some embodiments, the diameter of the cover is less than a quarter of the diameter of the wheel.

In some embodiments, the cover has a radius that is less than a difference between a radius of the wheel and a height of a lug of an endless track of the track system.

In some embodiments, in response to the wheel assembly abutting a lug of an endless track of a track system, the seal assembly is spaced from the lug.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by a driver of a vehicle to which the track system is connected, in which the driver is sitting on the vehicle in an upright driving position, with the vehicle steered straight-ahead and being at rest on flat, level ground.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description and the accompanying drawings.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates a left side elevation view of an all-terrain vehicle equipped with track systems that include wheel assemblies with seal assemblies, in accordance with an embodiment of the present technology;

FIG. 2 illustrates a perspective view from a bottom, front, and left side of a front left track system of the all-terrain vehicle of FIG. 1;

FIG. 3 illustrates a perspective view from a top, front, and left side of a wheel assembly of the track system of FIG. 2;

FIG. 4 illustrates a cross-sectional view taken along a center plane of the wheel assembly of FIG. 3;

FIG. 5 provides a magnified view of a wheel and its corresponding seal assembly within the wheel assembly of FIG. 3;

FIG. 6 illustrates a perspective view from a top, front, and right side of a section of the wheel and the corresponding seal assembly of FIG. 5;

FIG. 7 illustrates a perspective view from a top, rear, and right side of a seal of the corresponding seal assembly of FIG. 5;

FIG. 8 illustrates a perspective view from a top, rear and right side of an alternative embodiment of a seal of the corresponding seal assembly of FIG. 5; and

FIG. 9 illustrates a cross-sectional view taken along a horizontal center plane of the seal of FIG. 8.

FIG. 10 illustrates a perspective view of an alternative embodiment of a seal of the corresponding seal assembly of FIG. 5;

FIG. 11 illustrates a partial perspective cross-sectional view taken along a vertical plane of the seal of FIG. 10;

FIG. 12 illustrates a close-up cross-sectional view taken along a lateral center plane of a wheel assembly having the seal of FIG. 10; and

FIG. 13 illustrates the seal of FIG. 10 and a cover being connected to a wheel according to an embodiment of the present technology.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

The present technology relates to a seal designed for a wheel of a track system. The seal, which is a part of a seal assembly, is configured to seal an inner lateral side of the wheel to which it is connected. The configuration of the seal and the seal assembly are such that, during operation of the track system, the seal assembly does not engage with the endless track (that is, the seal assembly does not engage (e.g., contact) with lugs of the endless track in response to the wheel moving laterally relative to the endless track).

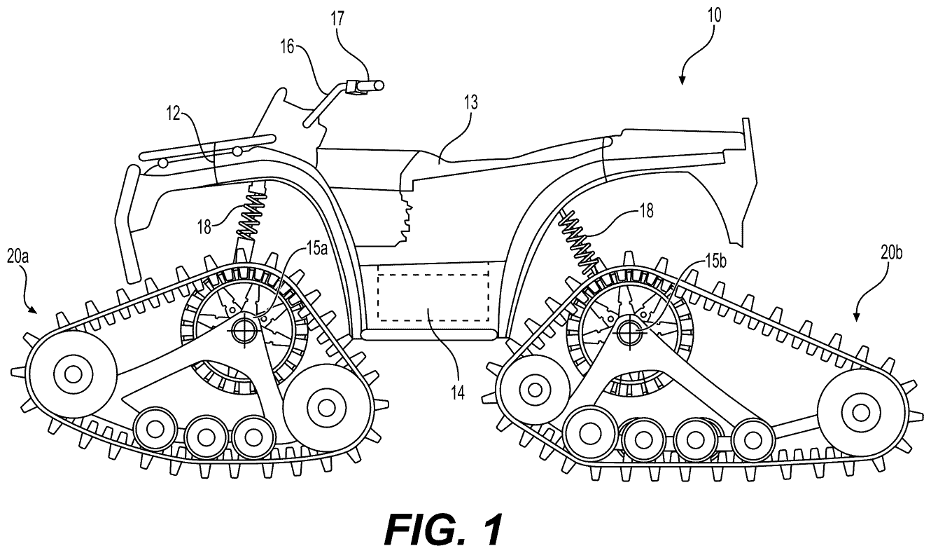

Referring to FIG. 1, the present technology will be described with reference to a vehicle 10. The vehicle 10 may be an off-road vehicle. More specifically, the vehicle 10 is an all-terrain vehicle (ATV). However, it is contemplated that in various other embodiments, the vehicle 10 may be another type of recreational vehicle such as a snowmobile, a side-by-side vehicle or a utility-task vehicle (UTV). In yet other embodiments, the vehicle 10 may be another type of vehicle such as a snowblower, a lawn mower or a robot. It is contemplated that the vehicle may be a zero-turn vehicle.

A person skilled in the art will understand that it is also contemplated that some aspects of the present technology in whole or in part could be applied to other types of vehicles such as, for example, agricultural vehicles, industrial vehicles, military vehicles or exploratory vehicles.

The vehicle 10 is equipped with two front track systems 20a (only the left track system 20a is depicted in the accompanying Figures) and two rear track systems 20b (only the left track system 20b is depicted in the accompanying Figures), in accordance with various embodiments of the present technology. In some embodiments, the vehicle 10 could have more or less than four track systems.

The vehicle 10 includes a frame 12, a straddle seat 13 disposed on the frame 12, a powertrain 14 (shown schematically), a steering system 16, a suspension system 18, and the track systems 20a, 20b.

The powertrain 14, which is supported by the frame 12, is configured to generate power and transmit said power to the track systems 20a, 20b via driving axles, thereby driving the vehicle 10. More specifically, the front track systems 20a are operatively connected to a front axle 15a of the vehicle 10 and, the rear track systems 20b are operatively connected to a rear axle 15b of the vehicle 10. It is contemplated that the powertrain 14 could be configured to provide its driving power to both the front and the rear axles 15a, 15b, or exclusively to either the front axle 15a or the rear axle 15b (i.e., in some embodiments, the front axle and/or the rear axle could be a driving axle).

The steering system 16 is configured to enable an operator of the vehicle 10 to steer the vehicle 10. To this end, in the illustrated embodiment, the steering system 16 includes a handlebar 17 that is operable by the operator to direct the vehicle 10 along a desired course. In other embodiments, the handlebar 17 could be replaced by another steering device such as, for instance, a steering wheel. The steering system 16 is configured so that in response to the operator handling the handlebar 17, an orientation of the front track systems 20a relative to the frame 12 is changed, thereby enabling the vehicle 10 to turn in a desired direction. In other embodiments, the steering system 16 could be configured to steer via a skid-steer mechanism.

The suspension system 18, which is connected between the frame 12 and the track systems 20a, 20b allows relative motion between the frame 12 and the track systems 20a, 20b, and can enhance handling of the vehicle 10 by absorbing shocks and assisting in maintaining adequate traction between the track systems 20a, 20b and the ground.

The track systems 20a, 20b are configured to compensate for and/or otherwise adapt to the suspension system 18 of the vehicle 10. For instance, the track systems 20a, 20b are configured to compensate for and/or otherwise adapt to alignment settings namely camber (i.e., a camber angle, “roll”), caster (i.e., a caster angle, “steering angle” and/or toe (i.e., a toe angle, “yaw”), which are implemented by the suspension system 18. As the vehicle 10 could have been originally designed to use wheels instead of the track systems, the alignment settings may have originally been set to optimize travel, handling, ride quality, etc. of the vehicle 10 equipped with wheels. Since the track systems 20a, 20b are structurally and functionally different from wheels, the track systems 20a, 20b may be configured to compensate for and/or otherwise adapt to the alignment settings to enhance their traction and/or other performance aspects and/or usage.

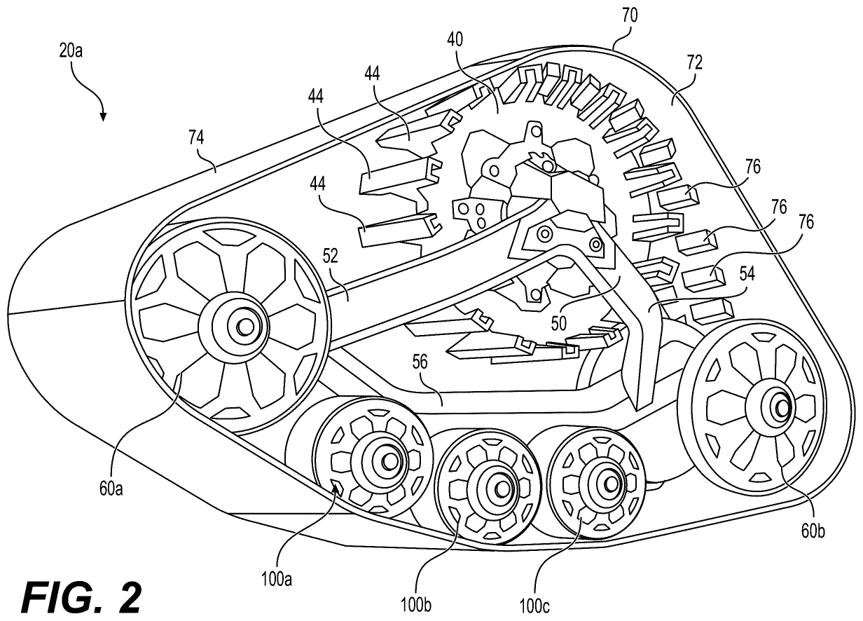

Referring now to FIG. 2, the front track systems 20a will now be described in greater detail. It is understood that the rear track systems 20b include features similar to those described herewith with reference to the track systems 20a.

The front track systems 20a include left and right track systems, which are similar to one another. Specifically, the left and right track systems are generally symmetrical about a longitudinal center plane of the vehicle 10. For this reason, only the left track system 20a (which is shown in the accompanying Figures) will be described herewith.

The track system 20a includes a sprocket wheel assembly 40 which is operatively connectable to the driving axle 15a. The driving axle 15a can drive the sprocket wheel assembly 40, which can, in turn drive the track system 20a. The sprocket wheel assembly 40 defines laterally extending engaging members 44 (i.e., teeth) disposed on the circumference of the sprocket wheel assembly 40. The engaging members 44 are adapted, as will be described in greater detail below, to engage with lugs 76 provided on an inner surface 72 of an endless track 70 of the track system 20a. It is contemplated that in other embodiments, the configuration of the sprocket wheel assembly 40 could differ without departing from the scope of the present technology.

The track system 20a further includes a frame 50, which includes a leading frame member 52, a trailing frame member 54 and a lower frame member 56. The leading and trailing frame members 52, 54 are jointly connected around the driving axle 15a, the joint connection being positioned laterally outwardly from the sprocket wheel assembly 40. The leading frame member 52 extends forwardly and downwardly from the joint connection and connects to a forward portion of the lower frame member 56. The trailing frame member 54 extends rearwardly and downwardly from the joint connection and connects to a rearward portion of the lower frame member 56. The lower frame member 56, which is positioned below the joint connection, extends generally parallel to the forward direction of travel of the vehicle. In the present embodiment, the leading, trailing and lower frame members 52, 54, 56 are integral. It is contemplated that in other embodiments, the leading, trailing and lower frame members 52, 54, 56 could be distinct members connected to one another. It is further contemplated that in some embodiments, the frame 50 could include more or less than three members. In some embodiments, one or more of the leading, trailing and lower frame members 52, 54, 56 could be pivotally connected to one another.

With continued reference to FIG. 2, the track system 20a further includes a leading idler wheel assembly 60a, a trailing idler wheel assembly 60b, and three-wheel assemblies 100a, 100b, 100c.

The leading idler wheel assembly 60a is rotationally connected to a leading end of the lower frame member 56, the trailing idler wheel assembly 60b is rotationally connected to a trailing end of the lower frame member 56, and the support wheel assemblies 100a, 100b, 100c are connected to the lower frame member 56 such that the support wheel assemblies 100a, 100b, 100c are disposed longitudinally between the leading and trailing idler wheel assemblies 60a, 60b. The wheel assemblies 60a, 60b, 100a, 100b, 100c will be described in greater detail herebelow.

In some embodiments, at least one of the leading and trailing idler wheel assemblies 60a, 60b could be connected to the lower frame member 56 via a tensioner (not shown), wherein the tensioner is operable to adjust the tension in the endless track 70 by selectively moving the at least one of the leading and trailing idler wheel assemblies 60a, 60b closer to or away from the frame 50.

The track system 20a also includes the endless track 70, which extends around components of the track system 20a, notably the frame 50 and the wheel assemblies 60a, 60b, 100a, 100b, 100c. The endless track 70 has the inner surface 72 and an outer surface 74. The inner surface 72 of the endless track 70 has the left and right sets of lugs 76. The left and right sets of lugs 76 are adapted to engage with the engaging members 44 of the sprocket wheel assembly 40. It is contemplated that in some embodiments, there could be only one set of lugs 76. The outer surface 74 of the endless track 70 has a tread (not shown) defined thereon. It is contemplated that the tread could vary from one embodiment to another. In some embodiments, the tread could depend on the type of vehicle 10 on which the track system 20a is to be used and/or the type of ground surface on which the vehicle 10 is destined to travel. In the present embodiment, the endless track 70 is an elastomeric endless track. Specifically, the endless track 70 is a polymeric endless track. It is contemplated that in some embodiments, the endless track 70 could have reinforcing members disposed therein.

It is contemplated that features of the track system 20a may vary from one embodiment to another. In some embodiments, the track system 20a may have one or more features of the track system described in U.S. patent application Ser. No. 17/575,478, filed Jan. 13, 2022 entitled “Multi-Feature Track System with Enhanced Performance”, which is incorporated by reference herein in its entirety.

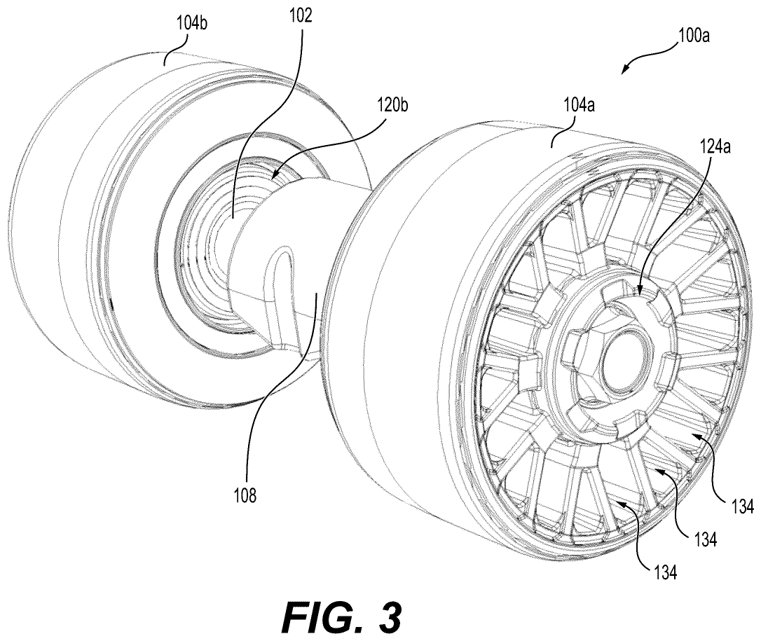

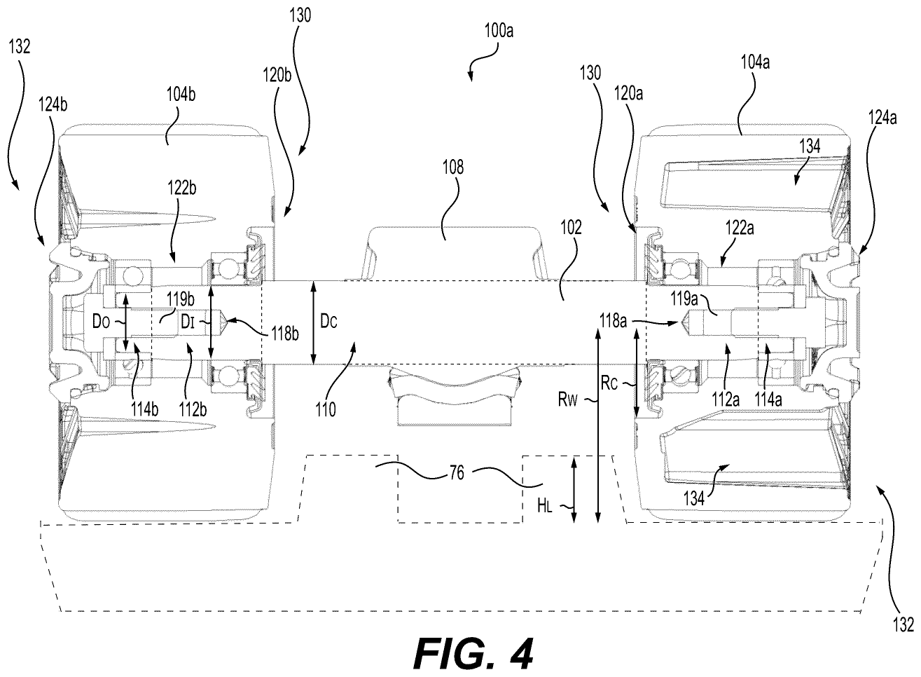

With reference to FIGS. 3 and 4, the support wheel assemblies 60a, 60b, 100a, 100b, 100c will now be described in greater detail. Since the support wheel assemblies 60a, 60b, 100a, 100b, 100c are all similar, only the support wheel assembly 100a will be described herewith.

The support wheel assembly 100a includes a shaft 102, left and right wheels 104a, 104b, left and right inner seal assemblies 120a, 120b, left and right connecting assemblies 122a, 122b, and left and right outer seal assemblies 124a, 124b. In other embodiments, the support wheel assembly 100a may include more or fewer components. The interconnections between the above-mentioned assemblies will be described in greater detail below.

The shaft 102, extending generally laterally relative to a center plane of the track system 20a, is connected to the lower frame member 56 via a connecting assembly 108 (partially shown in FIGS. 3 and 4). It is contemplated that in some embodiments, the connecting assembly 108 may have a resilient member, enabling the shaft 102 to move (for instance, pivot) relative to the lower frame member 56. In other embodiments, the shaft 102 could be rigidly connected to the lower frame member 56 without the use of the connecting assembly 108.

As best seen in FIG. 4, the shaft 102 has a central section 110, intermediate sections 112a, 112b, and outer sections 114a, 114b, wherein a diameter of the shaft 102 changes at each section and the various sections are delimited by dashed lines in the accompanying Figures. The intermediate section 112a extends laterally outwardly from a left side of the central section 110, and the outer section 114a extends laterally outwardly from a left side of the intermediate section 112a. Similarly, the intermediate section 112b extends laterally outwardly from a right side of the central section 110, and the outer section 114b extends laterally outwardly from a right side of the intermediate section 112b. The shaft 102 has a diameter Dc at the central section 110, a diameter DI at the intermediate sections 112a, 112b, and a diameter Do at the outer sections 114a, 114b. The diameter Dc is greater than the diameters DI, Do, and the diameter DI is greater than the diameter Do. It is contemplated that in other embodiments, the shaft 102 may have more or fewer sections, and a diameter thereof could change more or fewer times. The shaft 102 defines, at each end thereof, apertures 118a, 118b. As will be described in greater detail below, the apertures 118a, 118b are configured to receive, respectively, fasteners 119a, 119b.

The left wheel 104a is rotationally connected to a left end of the shaft 102 via the connecting assembly 122a, and the right wheel 104b is rotationally connected to a right end of the shaft 102 via the connecting assembly 122b. It is contemplated that in some embodiments, one or both of the left and right wheels 104a, 104b may be replaced by one or more tandem assemblies. The support wheel assembly 100a is configured (for instance, the shaft 102 is dimensioned) such that the left wheel 104a is disposed laterally outwardly from the left set of lugs 76 (shown schematically in FIG. 4), and that the right wheel 104b is disposed laterally outwardly from the right set of lugs 76 (shown schematically in FIG. 4).

As the wheels 104a, 104b are similar to one another, only the wheel 104a and the assemblies connected thereto will be described in detail herewith.

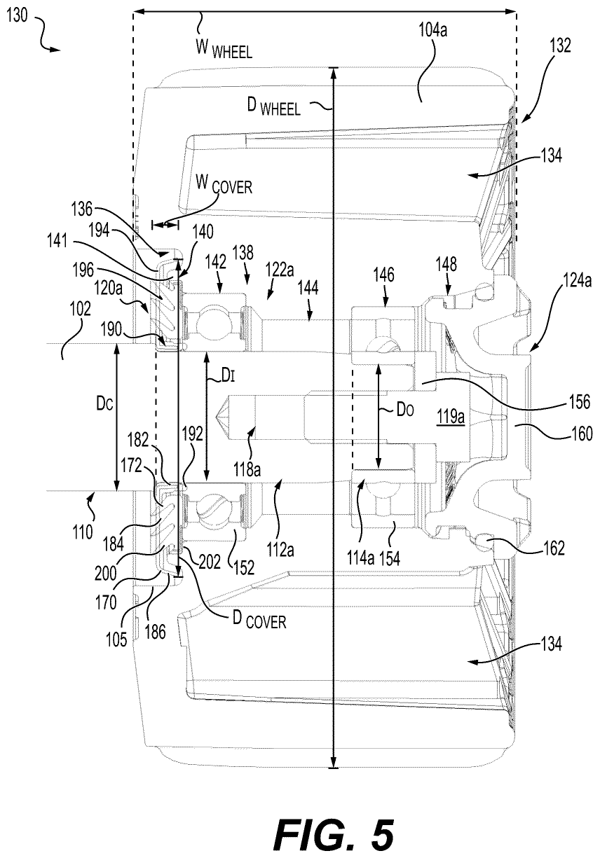

As seen in FIG. 5, the wheel 104a has an inner lateral side 130 that is oriented toward the lugs 76 and an outer lateral side 132. On the outer lateral side 132, the wheel 104a defines a plurality of recesses 134. The presence of the recesses 134 can assist in reducing material required to manufacture the wheel 104a, which can reduce manufacturing costs. It is understood that in some embodiments, the recesses 134 could be omitted.

On the inner lateral side 130 thereof, the wheel 104a defines an annular recess 136. As will be described in greater detail below, the annular recess 136 is configured to at least partially receive the inner seal assembly 120a therein.

Furthermore, the wheel 104a also defines a central aperture 138 that is configured to at least partially receive the shaft 102, the inner seal assembly 120a, the connecting assembly 122a and the outer seal assembly 124a, and that extends therethrough (that is, generally from the inner lateral side 130 to the outer lateral side 132). The central aperture 138 has various sections that vary in diameter.

The central aperture 138 has sections 140, 142, 144, 146, 148, with the section 140 being closest to the inner lateral side 130 and the section 148 being closest to the outer lateral side 132. The section 142 extends laterally outwardly from the section 140. The section 144 extends laterally outwardly from the section 142, and generally corresponds to a middle section of the central aperture 138. The section 146 extends laterally outwardly from the section 144 to the section 148. As mentioned above, and as will be described in greater detail below, the sections 140, 142, 144, 146, 148 vary in diameter. It is contemplated that in other embodiments, there could be more or fewer sections, and that two or more of the sections could have the same diameter.

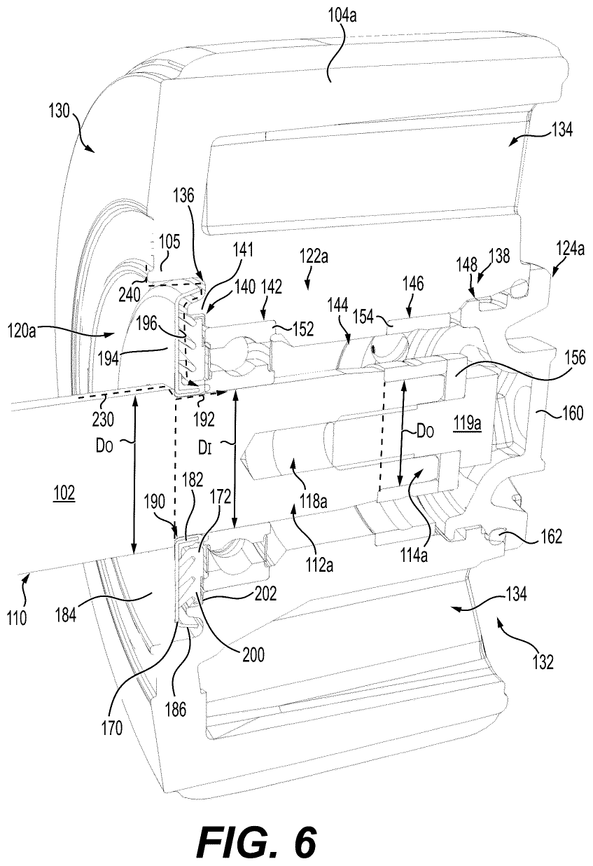

As best seen in FIG. 6, the section 140 is partially defined by a retaining portion 141 of the wheel 104a, which is disposed, radially, between the annular recess 136 and the section 140. The retaining portion 141 is, in the present embodiment, a shoulder 141. The section 140 can be referred to, in some instances, as an outer recess. The section 140, as will be described in greater detail below, is configured to at least partially receive the inner seal assembly 120a therein.

The sections 142, 146, 148 are configured to at least partially receive the connecting assembly 122a. In more detail, the connecting assembly 122a, which rotationally connects and keeps the wheel 104a connected to the shaft 102, includes a bearing 152, a bearing 154, stopper 156 and the end fastener 119a. It is contemplated that in other embodiments, the connecting assembly 122a could include more or fewer components. For example, in some embodiments, the connecting assembly 122a may include a sleeve.

In the embodiment illustrated in FIG. 6, the bearing 152 is received in the section 142 of the central aperture 138. The inner lateral end of the bearing 152 abuts the inner seal assembly 120a, whereas the outer lateral end of the bearing 152 abuts the wheel 104a due to the diameter of the central aperture 138 at the section 144 being smaller than the diameter of the central aperture 128 at the section 142. It is contemplated that in some embodiments, the outer lateral end of the bearing 152 may be spaced from the section 144 (i.e., the outer lateral end of the bearing 152 does not necessarily have to abut the wheel 104a).

The bearing 154 is received in the section 146 of the central aperture 138 such that the bearing 154 is laterally spaced from the bearing 152. The inner lateral end of the bearing 154 abuts the wheel 104a (due to the diameter of the central aperture 138 at the section 146 being greater than the diameter of the central aperture 138 at the section 144) as well as the shaft 102 (due to the diameter DI being greater than the diameter Do). The outer lateral end of the bearing 154 abuts the stopper 156.

The stopper 156 is connected to the shaft 102 via the end fastener 119a. More specifically, the fastener 119a is fastened to the stopper 156, and to the shaft 102 via the end aperture 118a. The stopper 156 and the end fastener 119a partially extend into the section 148. The stopper 156 is dimensioned to have a diameter that is larger than the diameter Do so that when the stopper 156 is connected to the shaft 102, the stopper 156 abuts the bearing 154. Thus, when the stopper 156 is connected to the shaft 102, the stopper 156 stops movement of the bearing 154 in the outer lateral direction. In the embodiment illustrated in FIG. 6, the end fastener 119a is selectively connected to the stopper 156 and the shaft 102. Thus, the wheel 104a is selectively connected to the shaft 102. Other configurations of connections between the shaft 102, the bearings 142, the wheel 104 and/or the stopper 156 are contemplated as well.

The bearings 152, 154 depicted in FIG. 6 have different sizes, but it is contemplated that in other embodiments, the bearings 152, 154 may be of the same size and consequently, the sections 142, 146 would also be of the same size.

Furthermore, the section 148 is configured to receive part of the outer seal assembly 124a which is adapted to, from the outer lateral side 132 of the wheel 104a, protect components disposed in the central aperture 138 (e.g., bearings 152, 154) from various elements such as water and/or debris. The outer seal assembly 124a includes an outer cap 160 and a sealing member 162. It is contemplated that in some embodiments, the outer seal assembly 124a could further include retaining members or similar members. In some embodiments the outer seal assembly 124a may have some similarities with the outer seal assembly described in United States Patent Application Publication No. 20220219769, entitled “Multi-Feature Track System with Enhanced Performance” filed on Jan. 13, 2022, the content of which is incorporated herein by reference in its entirety.

With reference to FIGS. 3 to 6, the inner seal assembly 120a will now be described in greater detail. The inner seal assembly 120a includes a seal 172 and a cover 170. It is contemplated that in other embodiments, the inner seal assembly 120a may include additional components. As will be described below, when the inner seal assembly 120a is connected to the wheel 104a, the cover 170 engages the seal 172, such that the seal 172 is resiliently deformed, thereby providing a seal on the inner lateral side 130 of the wheel 104a. Additionally, the seal assembly 120a is embedded into the wheel 104a. In other words, the seal assembly 120a is positioned such that it does not protrude from the inner lateral side 130 of the wheel 104a.

The cover 170, which has a generally annular shape, has an inner radial segment 182, an intermediate radial segment 184 and an outer radial segment 186.

The inner radial segment 182 extends in the lateral direction. More specifically, the inner radial segment 182 extends in the outer lateral direction. The inner radial segment 182 defines an aperture 190 that is dimensioned to receive the shaft 102 therein. More specifically, the aperture 190 is sized such that the shaft 102 and the inner radial segment 182 are generally fixed together (e.g., through a transition fit or an interference fit, use of an adhesive, etc.). As will be described in greater detail below, a sealing layer 192 is provided around the inner radial segment 182.

The intermediate radial segment 184, generally extending perpendicularly from a laterally inner end of the inner radial segment 182, extends in a radial direction as well. The intermediate radial segment 184 has a surface 194 that is configured to abut the shaft 102 (due to the diameter DC being greater than the diameter DI), and a surface 196 that is configured to engage the seal 172. The abutment between the shaft 102 and the surface 194 can assist in positioning the cover 170 relative to the shaft 102. As will be described below, the sealing layer 192 extends around part of the intermediate radial segment 184. In some embodiments, the sealing layer 192 could be configured to not extend around the intermediate radial segment 184 at all.

The outer radial segment 186, extending angularly from the intermediate radial segment 184, also extends both in radial and lateral directions. The outer radial segment 186 is dimensioned and oriented to be at least partially received in the annular recess 136. As best seen in FIG. 5, the cover 170 is positioned such that the surfaces 194, 196 are laterally offset from the inner lateral side 130, and more specifically, are disposed laterally between the inner and outer lateral sides 130, 132. In other words, the wheel 104 and the cover 170 are configured such that the cover 170 does not protrude outwardly from the inner lateral side 130 of the wheel 104, where the inner lateral side 130 may be defined by the laterally innermost point of the wheel 104. In yet other embodiments, the wheel 104 may be configured such that the cover 170 could extend outwardly from the inner lateral side 130. As will be described below, the outer radial segment 186 being received in the annular recess 136 can assist in reducing exposure of debris such as mud or water.

The segments 184, 186 extend radially such that a diameter D_{cover} of the cover 170 is less than a diameter D_{wheel} of the wheel 104a. In some embodiments, the diameter D_{cover} is about a third of the diameter D_{wheel}. In other embodiments, the diameter D_{cover} is about two thirds of the diameter D_{wheel}. In other embodiments, the diameter D_{cover} is about half of the diameter D_{wheel}. In other embodiments, the diameter D_{cover} is about a quarter of the diameter D_{wheel}. Other such ratios are contemplated. In some embodiments, the diameter D_{cover} could vary depending on a height of the lugs 76 of the track system 70.

Indeed, in some embodiments, the diameter D_{cover} could be adjusted so that a top of the lug 76 is vertically spaced from a bottom of the cover 170. As will be described below, this can assist in preventing the cover 170 from engaging the lugs 76 when the lugs 76 move relative to the wheel 104a, and engage therewith. It is contemplated that in other embodiments, the cover 170, the wheel 104a and the lugs 76 may be sized differently.

Additionally, the cover 170 provides, in the present embodiment due to the segments 182, 186 extending laterally, a receiving volume configured to receive, at least partially, the seal 172 therein. A width of the seal assembly 170 can thus be generally estimated as being similar to a width of the cover 170. In some embodiments, a width W_{cover} of the cover 170 is between 4.4 millimeter and 4.8 millimeter. In some embodiments, a width W_{cover} of the cover 170 is 4.4 millimeter. In some embodiments, the width W_{cover} of the cover 170 could be about 4 millimeters. In some embodiments, the width W_{cover} of the cover 170 could be about 3 millimeters. In some embodiments, the width W_{cover} of the cover 170 could be about 5 millimeters. In some embodiments, the width W_{cover} of the cover 170 could be about 6 millimeters. In some embodiments, the width W_{cover} of the cover 170 could be about 7 millimeters. In some embodiments, the width W_{cover} of the cover 170 could be about 8 millimeters. In some embodiments, the width W_{cover} of the cover 170 could be about 9 millimeters.

It is contemplated that in some embodiments, the configuration of the cover 170 could change. For example, in some embodiments, the inner radial segment 172 that extends in the lateral direction could be omitted. In other embodiments, the sealing layer 192 could be omitted.

The cover 170 also includes the sealing layer 192 that surrounds the inner radial segment 182 and part of the intermediate radial segment 186. The sealing layer 192 is described in detail in U.S. Provisional Patent Application No. 63/347,100, filed May 31, 2022 entitled “Support Structure Having a Seal for a Track Assembly and Support Structure Having a Guide Rail” which is incorporated by reference herein in its entirety. In the illustrated embodiment, the sealing layer 192 is made of a resilient material. Specifically, the sealing layer 192 is made of an elastomeric material. It is contemplated that in other embodiments, the sealing layer 192 could be made of a non-resilient material that is different from the material of the shaft 104, and that is sufficiently deformable (malleable) to provide a seal between the shaft 104 and the wheel 104a. For example, the sealing layer 192 could be made of, for example, aluminum or brass. As will be described in greater detail below, the sealing layer 192 is configured to deform when the shaft 102 is received in the aperture 190 so as to provide a seal therebetween.

Referring to FIGS. 3 to 7, the seal 172 having a scaling portion 200 and a positioning portion 202, will now be described in greater detail.

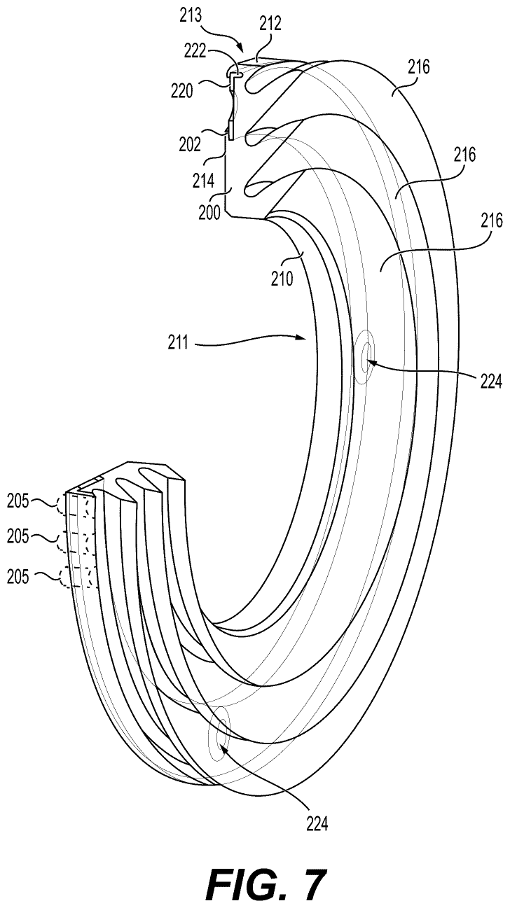

The sealing portion 200 is generally annular, such that the sealing portion 200 has an inner radial surface 210 at an inner end 211 and an outer radial surface 212 at an outer radial end 213. The sealing portion 200 is dimensioned such that the inner radial surface 210 surrounds the inner radial segment 182, and such that the outer radial surface 212 abuts the shoulder 141 defining the section 140. In some instances, at least part of the radial surface 212 may not abut the shoulder 141. As best seen in FIG. 7, the outer radial surface 212 extends around the positioning portion 202, such that when the seal 172 is in position, the outer radial surface 212 extends between the positioning portion 202 and the shoulder 141. The outer radial surface 212, by deforming (e.g., compressed between the positioning portion 202 and the shoulder 141) assists in establishing a seal. In some instances, the outer radial surface 212 can be generally aligned with the positioning portion 202. Furthermore, the sealing portion 200 has a generally flat surface 214 on one lateral side thereof, and lips 216 on the other lateral side thereof. In the illustrated embodiments, the scaling portion 200 has three lips 216. It is contemplated, however, that the scaling portion 200 could have one, two or four or more lips. The configuration and design of the scaling portion 200 could vary from one embodiment to another without departing from the scope of the present technology. In this embodiment, each one of the lips 216 extends radially and laterally away from the inner radial surface 210 (i.e., away from the shaft 102). Such configuration can assist in blocking elements such as dust, water and/or debris coming from a radially outer portion of the inner seal assembly 120a from reaching internal components such as the bearing 152. It is to be noted that having two or more lips 216 typically provides a better barrier against dust, water and debris than a single lip. The sealing portion 200 is made of an elastomeric material. In some embodiments, the elastomeric material is a polymeric material such as rubber. As will be described in greater detail below, the sealing portion 200, upon deformation, establishes a seal.

As will be described in greater detail below, the positioning portion 202 is configured to provide rigidity. Thus, the positioning portion 202 may be referred to as a reinforcing portion. Additionally, the positioning portion 202 is also configured to position the seal 172 in the section 140 of the central aperture 138. The positioning portion 202 is connected to the sealing portion 200. More specifically, the positioning portion 202, which is also annular, is connected to the generally flat surface 214 proximate to the outer radial surface 212. The sealing portion 202 has a segment 220 and a segment 222 that extends generally perpendicularly to the segment 220. The segment 220 extends along part of the generally flat surface 214, whereas the segment 222 extends generally parallel to the outer radial surface 212. As mentioned above, the segment 222 is disposed radially inwardly from the outer radial surface 212. In some embodiments, the segment 222 could be radially aligned with the outer radials surface 212. It is contemplated that in some embodiments, the segment 222 could be omitted. The segment 220 provides an area of contact between the positioning portion 202 and the sealing portion 200. In some instances, the segment 220 covers about a quarter of an area of the generally flat surface 214. In other embodiments, the segment 220 could cover about a third of an area of the generally flat surface 214. In other embodiments, the segment 220 could cover about a fifth of an area of the generally flat surface 214. The area covered by the segment 220 could vary from one embodiment to another depending on a variety of reasons including application, material properties of the seal 172. In some embodiments, the sealing and positioning portions 200, 202 are connected to one another via overmolding. To this end, the segment 220 defines four apertures 224 (only two shown in FIG. 7) that are equally angularly spaced and that assist in positioning the positioning portion 200 with respect to a mold. In other embodiments, there could be more or fewer than four apertures 224. In other embodiments, the apertures 224 could be omitted, and the sealing and positioning portions 200, 202 could be connected differently (for instance, by use of an adhesive or glue, etc.).

The positioning portion 202 is more rigid than the scaling portion 200. In some instances, the positioning portion 202 is made of a rigid material such as a metallic material and/or a hard plastic.

In some instances, the seal 172 could also have interlockers 205 (some being depicted schematically in FIG. 7). In FIGS. 7 to 9, the interlockers 205 are radially extending segments that can assist (e.g., via engagement with complementary interlockers of the wheel 104a) in rotationally fixing the seal 172 relative to the wheel 104. In some embodiments, the interlockers 205 could be extensions of the sealing portion 200. In other embodiments, the interlockers 205 could be extensions of the positioning portion 202. As will be described below, it is contemplated that the interlockers 205 may extend differently, such as, for example, axially.

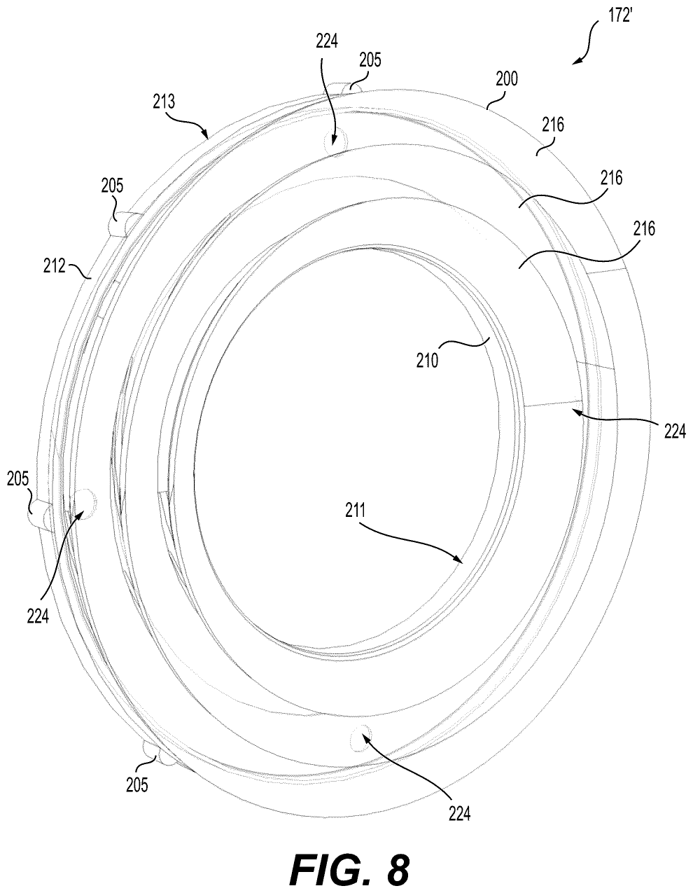

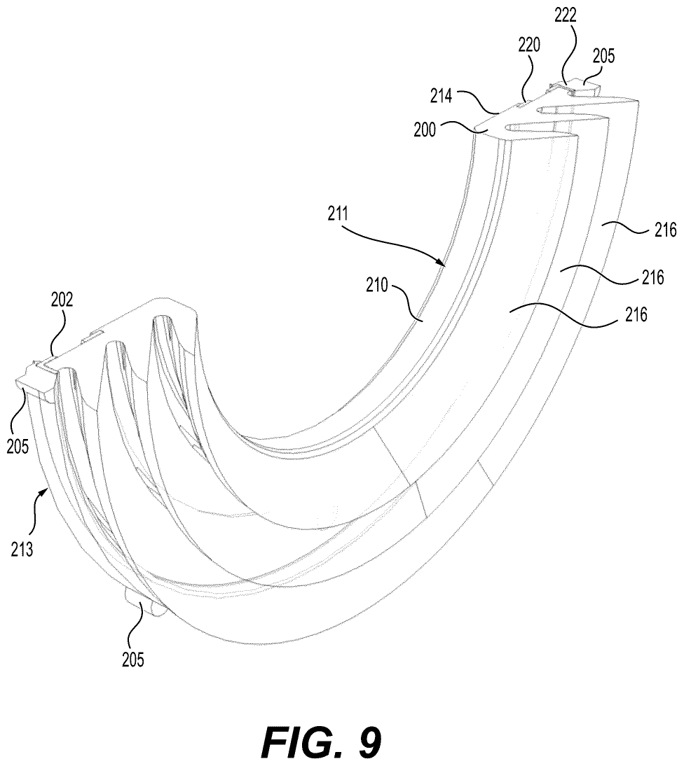

In FIGS. 8 and 9, an alternative embodiment of the seal 172, namely seal 172′, is shown. Components of the seal 172′ similar to those of the seal 172 have been labeled with the same reference numerals and will not be described again. The seal 172′ has eight interlockers 205 that are disposed on the circumference of the seal 172. It is contemplated that in other embodiments, there could be more or less than eight interlockers 205. In the illustrated embodiment, the interlockers 205 are part of the sealing portion 200. Each one of the interlockers 205 extends in the radial direction, and partially axially, and has a generally arcuate profile. In other embodiments, each one of the interlockers 205 could have another profile shape, such as, for example, triangular, square or rectangular profiles.

It is contemplated that in some embodiments, the wheel 104a and/or the inner seal assembly 120a may have one or more features described in U.S. Provisional Patent Application No. 63/625,058, filed Jan. 25, 2024 entitled “Bearing Assembly with Protective Flanged Seal Structure for Track System Wheels”, which is incorporated by reference herein in its entirety.

Referring back to FIGS. 5 and 6, during assembly of the support wheel assembly 100a, the seal 172 is received in the section 140 of the central aperture 138. As a result of the reduced footprint of the seal assembly 120a, the seal 172 can no longer be installed by being stretched around a given feature (e.g., sleeve extending from the wheel 104a), because of the absence of such a feature (i.e., a lateral footprint of the seal assembly 120a was in part reduced by omitting some laterally extending features). Instead, the positioning portion 202 assists in ensuring that the seal assembly 120a is properly positioned in the section 140 by abutting the shoulder 141. The positioning portion 202 can rigidify the seal 172 in order to secure the seal 172 in position so as to limit, in some cases prevent altogether, axial and/or radial movement of the seal 172 relative to the shaft 102. It is contemplated that in other embodiments, the seal 172 may be secured differently (i.e., by an interference fit or an interference fit and with mechanical interlock). The positioning portion 202 is sufficiently rigid so that the position of the seal assembly 120a is substantially unchanged during assembly. Thus, the positioning portion 202 can be referred to as a securing portion 202, as it assists in securing the seal 172 relative to the wheel 104a. In some instances, the interlockers 205 can provide a mechanical interlock between the wheel 104a and the seal assembly 120a. As will be described below, the configuration of the seal 172, in that it is selectively received in the recess 136 facilitates its replacement.

When the support wheel assembly 100a is fully assembled, the seal 172 is resiliently deformed (via compression) between the cover 170 and the wheel 104 and/or the bearing 152, thereby sealing a radially outer portion of the seal assembly 120a. The sealing layer 192 is resiliently deformed between the radially inner segment 182 and the shaft 102 such that the inner seal assembly 120 seals a radially inner portion the seal assembly 120a or the central aperture 138 from the inner lateral side 130 of the wheel 104a. In some other embodiments, the seal 172 can be provided with at least one additional lip configured to replace and/or act as the sealing layer 192, and thus, seal the central aperture 138 from the inner lateral side 130 of the wheel 104a. To this end, in some cases, the at least one additional lip can extend inwardly (i.e., towards the shaft) to block elements such as dust, water and debris from entering by the radially inner portion of the seal assembly 120a. In some embodiments, part of the sealing portion 200, which includes the lips 216 can be considered to be a dynamic part of the seal 172, as it may move with respect to the cover 170, and an other part of the sealing portion 200, which includes the other generally flat surface, may be considered to be a static part of the seal 172, as it does not move relative to the race of the bearing 152 it is connected to.

In more detail, the connection of the cover 170 and the shaft 102 is such that the sealing layer 192 is resiliently deformed. This resilient deformation establishes a seal that can assist in limiting entry of debris such as water or mud into the central aperture 138 through a pathway 230 (illustrated by dotted lines in FIG. 6) extending between the shaft 102 and the cover 170.

It is to be noted that the present technology, inter alia, contributes to reducing the radial and lateral footprint of the seal assembly 120a, primarily because the seal 172 does not require extension around a given feature of the wheel 104a and/or the shaft 102. Instead, the positioning portion 202 assists, as described above, in the installation of the seal assembly 120a on the wheel 104a.

In this embodiment, the cover 170 is disposed laterally, in its entirety, between the inner and outer lateral sides 130, 132 of the wheel 104a (e.g., the surface 194 is laterally offset from the inner lateral surface 130). As a result, the wheel 104a has an overhang 105. The overhang 105 can assist in limiting the amount of debris that reaches an interface between the seal assembly 120a and the wheel 104 (e.g., amount of debris reaching the annular recess 136 is reduced to the presence of the overhang 105). The dotted line in FIG. 6 illustrates a pathway 240 that debris would have to follow to enter through a radially outer portion of the seal assembly 120a.

Furthermore, since the cover 170 is disposed laterally inwardly from the inner lateral side 130, in situations where the support wheel assembly 100a moves relative to the endless track 70 such that the lugs 76 moves toward the wheel 104a, the lugs 76 first engage the wheel 104a instead of the inner seal assembly 120a, which can extend a life thereof.

Additionally, the present technology, inter alia, especially in view of the seal 172 not extending around a given feature such as the shaft or a sleeve of the wheel 104a, because of the positioning portion 202, contributes to a reduction in the radial footprint of the seal assembly 120a. As a result, akin to what was described hereabove, when the support wheel assembly 100a moves relative to the endless track 70 such that the lugs 76 moves toward the wheel 104a, the lugs 76 first engage the wheel 104a instead of the inner seal assembly 120a.

It is also to be noted that due to the reduction in radial footprint of the seal assembly 120a, there is less friction between components of the seal assembly 120a, and the wheel 104 (e.g., the cover 170 and the wheel 104). This reduction in friction enhances durability of the track system and its overall performance by reducing the rolling resistance of the wheel 104 for instance. This is particularly advantageous for when the wheel 104 is rolling at higher RPMs.

Furthermore, due to its configuration, the seal 172 is also easily replaceable. Because of the presence of the positioning portion 202, the seal 172 does not need to the glued to a given component (e.g., wheel 104 and/or bearing 152) during installation. When the seal 172 is worn out, it can be replaced without having the replace the entire seal assembly 170. Alternatively, if needed, the cover 170 can be replaced while re-using the seal 172.

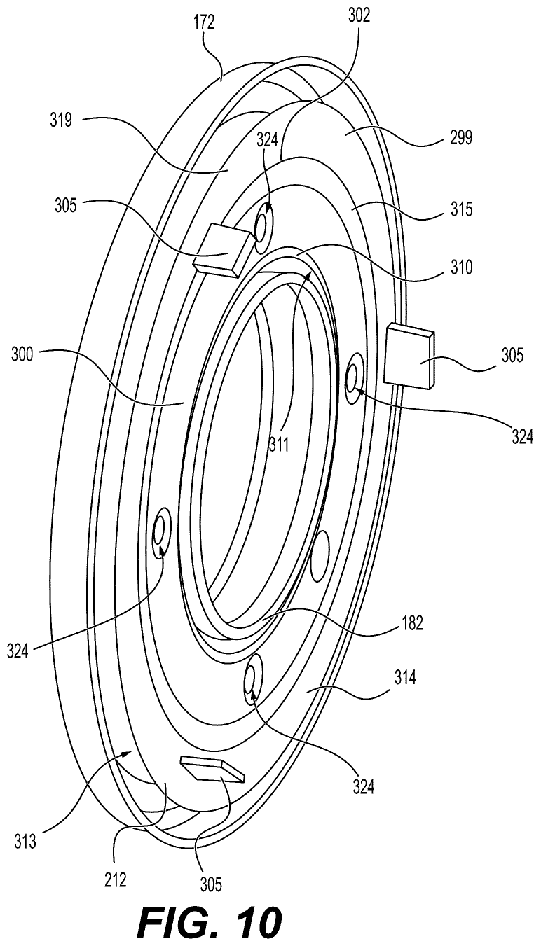

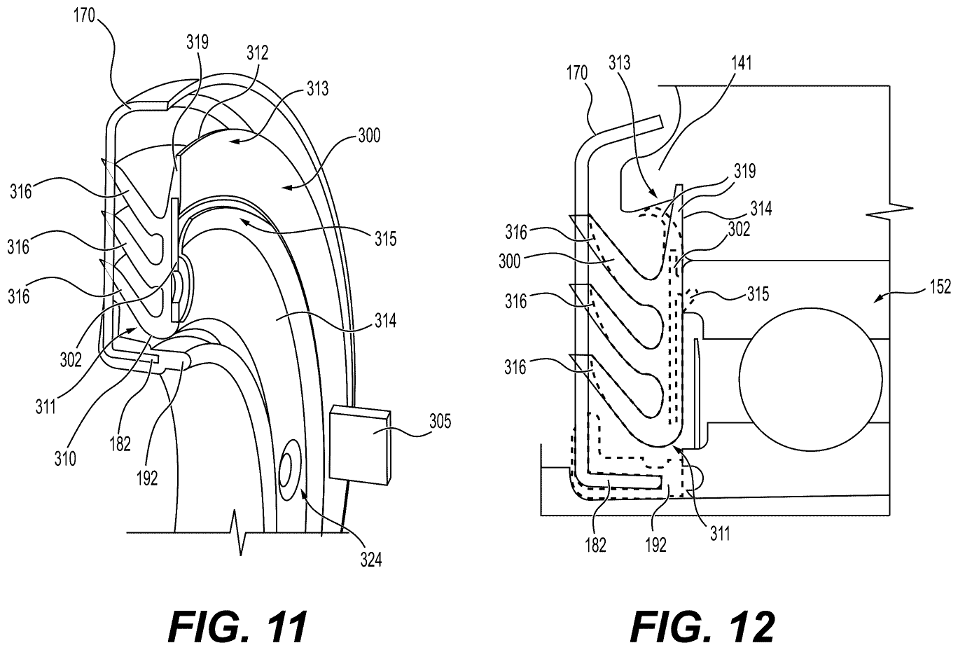

Referring to FIGS. 10 to 13, a description of a seal 299 according to an alternative embodiment of the present technology will now be provided. The seal 299 has a sealing portion 300 and a reinforcing portion 302.

The sealing portion 300 is generally annular, such that the sealing portion 300 has an inner radial surface 310 at an inner radial end 311 and an outer radial surface 312 at an outer radial end 313.

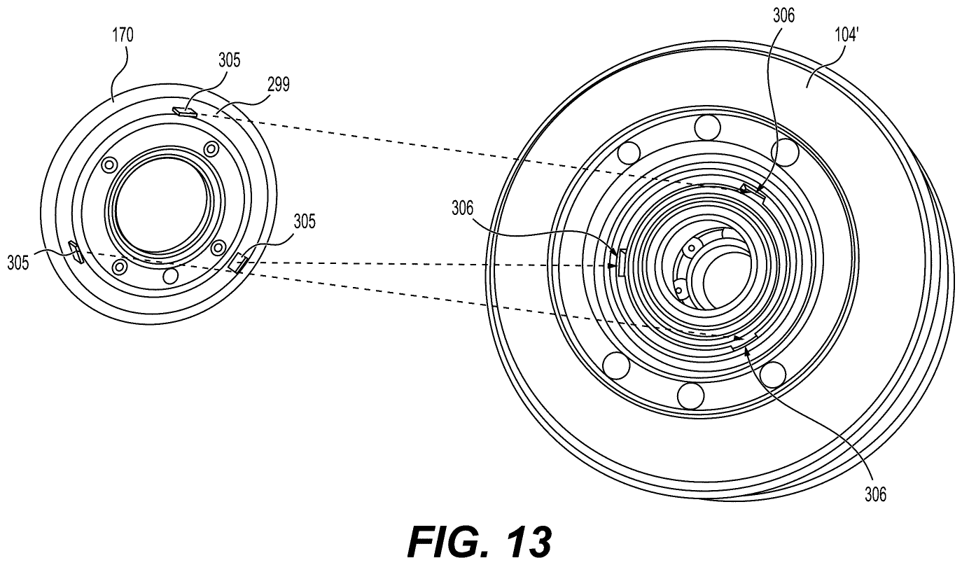

The sealing portion 300 is dimensioned such that the inner radial surface 310 is configured to surround the inner radial segment 182. More specifically, the sealing portion 300 is dimensioned such that when the seal 299 and the cover 170 are assembled, the inner radial surface 310 is spaced from the inner radial segment 182, so as to define a gap therebetween. This gap can assist in ensuring that the seal 299 does not engage with both races of the bearing 152 (in FIG. 12, the seal 299 is already in engagement with the outer race of the bearing 152, so the seal 299 should not engage the inner race of the bearing 152). This can limit wear that the seal 299 is subjected to.

At the outer radial end 313, the sealing portion 300 has a retention lip 319. Like the rest of the sealing portion 300, the retention lip 319 is resiliently deformable. As will be described below, the retention lip 319 is configured to engage the shoulder 141 for limiting movement of the seal 299 in the axial direction with respect to the wheel 104. The outer radial end 313, by deforming as shown by dotted lines in FIG. 12, further assists in establishing a seal.

Furthermore, the scaling portion 300 has, on one lateral side, a mostly flat surface 314, with a loading lip 315 extending angularly from the flat surface 314. In some embodiments, the loading lip 315 may be omitted. On the other lateral side thereof, the scaling portion 300 has lips 316. In the illustrated embodiments, the scaling portion 300 has three lips 316. It is contemplated, however, that the sealing portion 300 could have one, two or four or more lips. In this embodiment, each one of the lips 316 extends radially and laterally away from the inner radial surface 310 (i.e., away from the shaft 102). This can assist in blocking elements such as dust, water and/or debris coming from a radially outer end of the inner seal assembly 120a from reaching internal components such as the bearing 152. The sealing portion 300 is made of an elastomeric material. In some embodiments, the elastomeric material is a polymeric material such as rubber. As will be described in greater detail below, the sealing portion 300, upon deformation, establishes a seal.

The reinforcing portion 302 is connected to the sealing portion 300. More specifically, the reinforcing portion 302 is embedded in the scaling portion 300, near the generally flat surface 214. In some instances, the sealing portion 300 and the reinforcing portion 302 are connected to one another via overmolding. To this end, the reinforcing portion 302 defines four apertures 324 (shown in FIG. 10) that are equally angularly spaced and that assist in positioning the positioning portion 300 with respect to a mold. In other embodiments, there could be more or fewer than four apertures 324. In other embodiments, the apertures 324 could be omitted, and the scaling and positioning portions 300, 302 could be connected differently (for instance, by use of an adhesive or glue, etc.). In some embodiments, the sealing portion 300 may define a recess configured to receive the reinforcing portion 302 therein.

The reinforcing portion 302, like the sealing portion 300, has an annular shape. The reinforcing portion 302 has a radial thickness that spans a majority of a radial thickness of the sealing portion 300. It is contemplated that in some embodiments, the radial thickness of the reinforcing portion 302 could span at least about 90% of the radial thickness of the sealing portion 300. In other embodiments, the radial thickness of the reinforcing portion 302 could span at least about 80% of the radial thickness of the sealing portion 300. In other embodiments, the radial thickness of the reinforcing portion 302 could span at least about 70% of the radial thickness of the sealing portion 300. In other embodiments, the radial thickness of the reinforcing portion 302 could span at least about 60% of the radial thickness of the sealing portion 300. In other embodiments, the radial thickness of the reinforcing portion 302 could span at least about 50% of the radial thickness of the sealing portion 300. At least part of the reinforcing portion 302 is radially aligned with the loading lip 315.

The reinforcing portion 302 also has interlockers 305. In the illustrated embodiment, there are three interlockers 305 that are equally angularly spaced from one another. It is contemplated, however, that in other embodiments, the reinforcing portion 302 may have more or fewer than three interlockers 305. Each interlocker 305 extends in the axial direction, and has a rectangular profile. It is contemplated that the interlocker 305 may extend and/or be shaped differently. In the present embodiment, each one of the interlockers 305 is covered by the sealing portion 300. However, in other embodiments, each one of the interlockers 305 could be received through a respective aperture defined in the sealing portion 300. As will be described below, the interlockers 305 can assist in positioning and/or rotationally fixing the seal 299 relative to the wheel 104.

The reinforcing portion 302 is more rigid than the sealing portion 300. In some instances, the reinforcing portion 302 is made of a rigid material such as a metallic material and/or a hard plastic. The increased rigidity of the reinforcing portion 302 can assist in the sealing portion 300 retaining its shape. Additionally, the reinforcing portion 302 can assist in distributing axial loads more evenly to the sealing portion 200. Additionally, the reinforcing portion 302 can assist in distributing axial loads more evenly to the bearing 152. In some embodiments where part of the reinforcing portion 302 is aligned with part of the wheel 104a, part of the axial load can be distributed thereon, thereby reducing the load sustained by the bearing 152.

Referring to FIG. 13, to connect the seal 299 to the wheel 104′ (which is an alternative embodiment of the wheel 104a), the interlockers 305 are aligned with recesses 306 defined on the wheel 104′. Then, the seal 299 is pushed toward the wheel 104′. In some instances, the interlockers 305 and the recesses 306 are sized so as to prevent rotational movement of the seal 299 relative to the wheel 104′ once the seal 299 reaches a sealing position with respect to the wheel 104′ (shown by dotted lines in FIG. 12). In some embodiments, the interlockers 305 may be configured to provide a snap-fit engagement with the recesses 306 and prevent rotational and axial movement of the seal 299 relative to the wheel 104′. While the seal 299 is being moved toward the sealing position, the retention lip 319 engages the shoulder 141, and starts deforming. Once the seal 299 has reached its sealing position, the retention lip 319 is deformed, and maintains a seal in place, notably due to friction between the shoulder 141 and the retention lip 319. The retention lip 319 stays in position by itself due to an “over-center effect”, but can easily be removed if so desired. The seal 299 can removed by manually pulling the seal 299 away from the wheel 104′.

Additionally, while the seal 299 is moved toward the sealing position, the loading lip 315 is resiliently deformed, which applies a preloading force. This can enhance the sealing provided by the seal 299. In addition, the loading lip 315 provides an additional barrier which can further protect the bearing 152 from debris such as water and/or dust that may make their way past the other barriers. It will be appreciated that the presence of the reinforcing portion 302, being that it is generally radially aligned with the outer race of the bearing 152, can assist in distributing load across a whole radial length of the sealing portion 300.

It will be appreciated that the configuration of the seal 299 and the wheel 104′ can facilitate the assembly process, because the retention lip 319 starts retaining the seal 299 to the wheel 104′ without having to position the wheel 104′ in a specific configuration to counteract gravity or to use gravity during the assembly process.

Advantages of the seal 299 are similar to those described above with respect to the seal 172, and thus will not be re-described.

Modifications and improvements to the above-described embodiments of the present invention may become apparent to those skilled in the art. The foregoing description is intended to be exemplary rather than limiting. The scope of the present invention is therefore intended to be limited solely by the appended claims.

1. A seal for a wheel of a track system, the wheel defining a recess for receiving the seal, and the seal comprising:
a first portion being resiliently deformable and having an inner radial surface and an outer radial surface, the outer radial surface being configured to abut a retaining portion of the wheel, the retaining portion defining the recess; and
a second portion connected to the first portion, the second portion being more rigid than the first portion and being configured to secure the seal in the recess.

2. The seal of claim 1, wherein the first portion is made of an elastomeric material.

3. The seal of claim 1, wherein the second portion is made of a metallic material.

4. The seal of claim 1, wherein the second portion comprises:
a radial section; and
a lateral section extending generally perpendicular to the radial section, the lateral section being configured to abut at least one of: the retaining portion and the outer radial surface.

5. The seal of claim 1, wherein the first and second portions are connected to one another via overmolding.

6. (canceled)

7. The seal of claim 1, wherein the first portion of the seal comprises at least two lips.

8. The seal of claim 7, wherein each one of the at least two lips extends generally laterally outwardly and radially away from the inner radial surface.

9. The seal of claim 1, wherein the seal is selectively removable from the recess of the wheel.

10. The seal of claim 1, wherein a diameter of the second portion is smaller than a diameter of the recess.

11. A seal assembly for a wheel of a track system, the wheel having a lateral side, the seal assembly comprising:
a seal as defined in claim 1; and
a cover configured to engage with the seal, the engagement of the cover with the seal configured to cause at least partial resilient deformation of the first portion of the seal for sealing the lateral side of the wheel.

12. The seal assembly of claim 11, wherein the cover has a diameter that is less than half of a diameter of the wheel.

13. The seal assembly of claim 11, wherein the seal assembly is embedded into the wheel.

14. The seal assembly of claim 11, wherein the seal is selectively removable from the wheel and the cover.

15. A seal assembly for a wheel of a track system the seal assembly comprising:
a seal having an inner radial surface and an outer radial surface, the outer radial surface being configured to abut a shoulder of the wheel; and
a cover configured to engage with the seal, the engagement of the cover with the seal causing at least partial resilient deformation of the seal for sealing a lateral side of the wheel, the cover having a diameter that is less than half of a diameter of the wheel.

16. The seal assembly of claim 15, wherein the diameter of the cover is less than a quarter of the diameter of the wheel.

17. The seal assembly of claim 15, wherein a lateral surface of the cover is located laterally between inner and outer lateral sides of the wheel.

18. The seal assembly of claim 15, wherein the seal assembly has first interlockers selectively engageable to second interlockers of the wheel for providing a mechanical interlock between the seal assembly and the wheel.

19. The seal assembly of claim 15, wherein the seal assembly is configured to be at least partially received in a recess defined by the shoulder of the wheel.

20. The seal assembly of claim 19, wherein the seal is secured to the shoulder of the wheel by compression of the second portion of the seal.

21. The seal assembly of claim 15, wherein the seal comprises:
a first portion being resiliently deformable and having an inner radial surface and an outer radial surface; and
a second portion connected to the first portion proximate to the outer radial surface, the second portion being more rigid than the first portion for securing the seal relative to the wheel.

22.-34. (canceled)
